(19) United States
(12) Patent Application Publication
(10) Pub. No.: US 2014/0140671 A1
(43) Pub. Date: May 22, 2014

(54) OPTICAL FIBER / ELECTRICAL COMPOSITE CABLE ASSEMBLY WITH SEALED BREAKOUT KIT

(71) Applicant: ANDREW LLC, Hickory, NC (US)

(72) Inventor: Nahid ISLAM, Westmont, IL (US)

(73) Assignee: Andrew LLC, Hickory, NC (US)

(21) Appl. No.: 13/872,572

(22) Filed: Apr. 29, 2013

Related U.S. Application Data
(63) Continuation-in-part of application No. 13/791,248, filed on Mar. 8, 2013.
Application No. 13/791,248 is a continuation-in-part of application No. 13/832,665, filed on Mar. 15, 2013.
(60) Provisional application No. 61/728,020, filed on Nov. 19, 2012.

(51) Int. Cl. G02B 6/44

(52) U.S. Cl. CPC G02B 6/4439; G02B 6/4401; G02B 6/4471
USPC 385/101; 385/134; 385/136; 29/825

(57) ABSTRACT

A cable breakout kit has a cable portion, an inner wall portion and a furcation portion with at least one fiber port. The cable portion and the furcation portion are dimensioned to couple with one another, enclosing a furcation area. The inner wall portion is coupled to the furcation portion and a fiber bundle of the cable, enclosing a fiber area within the furcation area; the fiber area is coupled to the at least one fiber port. An assembly including a cable with a fiber and an electrical conductor utilizes a transition housing to pass the fiber and conductor to respective furcation tubes, isolated from one another. The fiber area is isolated from the furcation area and the furcation portion.

### BACKGROUND

1. Field of the Invention

This invention relates to hybrid electrical and optical cable assemblies. More particularly, the invention relates to a electrical and optical hybrid cable with an in-line transition housing between the hybrid cable and individual termination jumpers for the several conductors of the cable.

2. Description of Related Art

The wireless communications industry is changing from traditional signal delivery from ground based transceivers delivering/receiving the RF signal to/from the antenna atop the radio tower via bulky/heavy/high material cost metal RF coaxial cable to optical signal delivery to a tower top mounted transceiver known as a remote radio unit (RRU) or remote radio head (RRH) with implementation of FTTA (Fiber To The Antenna) cabling.

FTTA cabling may be simplified where power and/or control signal conductors are provided with optical signal conductors in a single hybrid cable.

Optical conductors may be fragile, requiring great care to properly terminate.

Prior hybrid cable RRU/RRH terminations have employed an over-voltage protection and/or distribution box for terminating each of the electrical and optical conductors as individual jumpers. These additional enclosures require field termination of the several conductors atop the radio tower, increasing installation time and labor requirements. Further, each break in the conductors provides another opportunity for signal degradation and/or environmental fouling.

Factory terminated hybrid cable assemblies are known. However, these assemblies may apply splices to the conductors, require a relatively large in-line break-out/splice enclosure and/or utilize environmental seals which fail to positively interlock the jumpers therewith, which may increase the potential for cable and/or individual conductor damage to occur.

Therefore, an object of the invention is to provide an optical fiber/electrical cable assembly with sealed breakout kit and/or cable assembly and method of use that overcomes deficiencies in the prior art.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1 is a schematic isometric view of an exemplary transition housing.

FIG. 2 is schematic side view of the transition housing of FIG. 1.

FIG. 3 is a schematic side view of a cable portion of the transition housing of FIG. 1.

FIG. 4 is schematic cut-away side view of the cable portion of FIG. 3.

FIG. 5 is a schematic isometric view of a furcation portion of the transition housing of FIG. 1.

FIG. 6 is a schematic cut-away side view of the furcation portion of FIG. 5.

FIG. 7 is a schematic end view of the transition end of the furcation portion of FIG. 6.

FIG. 8 is a schematic isometric cut-away view of the transition housing of FIG. 1.

FIG. 9 is schematic side section view of the transition housing of FIG. 8.

FIG. 10 is another schematic isometric cut-away view of the transition housing of FIG. 1.

FIG. 11 is schematic side section view of the transition housing of FIG. 10.

FIG. 12 is a schematic isometric view of the inner wall portion and end stop of the transition housing of FIG. 1.

FIG. 13 is a schematic cut-away side view of the inner wall portion of FIG. 12.

FIG. 14 is a schematic isometric view of an alternative inner wall portion.

FIG. 15 is a schematic cut-away side view of the inner wall portion of FIG. 14.

FIG. 16 is a schematic isometric view of an exemplary conductor furcation tube.

FIG. 17 is a schematic isometric view of an exemplary fiber furcation tube.

FIG. 18 is a schematic isometric partial cut-away view of a transition housing with cable and furcation tubes installed.

FIG. 19 is another schematic isometric partial cut-away view of the transition housing and cabling of FIG. 18.

FIG. 20 is a schematic isometric view of the transition housing and cabling of FIG. 18.

FIG. 21 is a schematic isometric view of one end of an exemplary cable assembly with a transition housing and connector terminated furcation tubes installed.

FIG. 22 is a schematic isometric view of an exemplary fiber capsule cap.

FIG. 23 is a schematic isometric view showing sidewall slots between fiber ports of the fiber capsule cap of FIG. 22.

FIG. 24 is a schematic partial cut-away side view of an embodiment of a transition housing with a fiber capsule.

FIG. 25 is a schematic close-up view of a portion of FIG. 24.

FIG. 26 is a schematic isometric view of the furcation portion of the transition housing of FIG. 24.

FIG. 27 is a schematic cut-away side view of the furcation portion of FIG. 26.

FIG. 28 is a schematic isometric view of an alternative furcation portion with a fiber capsule port.

FIG. 29 is a schematic end view of the furcation portion of FIG. 28.

FIG. 30 is a schematic isometric view of an inner wall portion dimensioned to seat within a fiber capsule port.

FIG. 31 is a schematic cut-away side view of the inner wall portion of FIG. 30.

FIG. 32 is a schematic isometric view of a transition housing with the inner wall portion of FIG. 30 seated in a fiber capsule port.

FIG. 33 is a schematic partial cut-away close-up side view of the transition housing of FIG. 32.

FIG. 34 is a schematic partial cut-away isometric view of an inner wall portion pre-assembly of a fiber bundle and fiber furcation tubes, the inner wall portion sealed with adhesive.

FIG. 35 is a schematic isometric view of an alternative inner wall portion.

FIG. 36 is a schematic cut-away side view of a transition housing with the inner wall portion of FIG. 35 installed via application of shrink tubing.

FIG. 37 is a schematic isometric partial cut-away view of a transition housing with fiber capsule, with cable and furcation tubes installed.

FIG. 38 is a close-up view of FIG. 38.

### DETAILED DESCRIPTION

The inventor has recognized that individual conductors of a hybrid electrical and optical conductor cable may be broken out into individual jumpers, without requiring termination and/or or splicing of the individual and/or groups of related conductors, by removing outer protective layers of the hybrid cable and providing protective sheaths for each of the conductors and/or conductor groups, the protective sheaths positively interlocked with the hybrid cable via a transition housing.

A typical hybrid cable, for example an FTTA cable, includes multiple metal (such as copper) conductors and single or multiple optical fibers in a subunit. A fiber subunit may include multiple optical fibers (such as 250 um or 900 um). In order to connect conductors and/or fibers directly to the RRH, optical fiber and power conductors are separated from the hybrid cable as individual jumpers, the jumpers protected with separate furcation tubes.

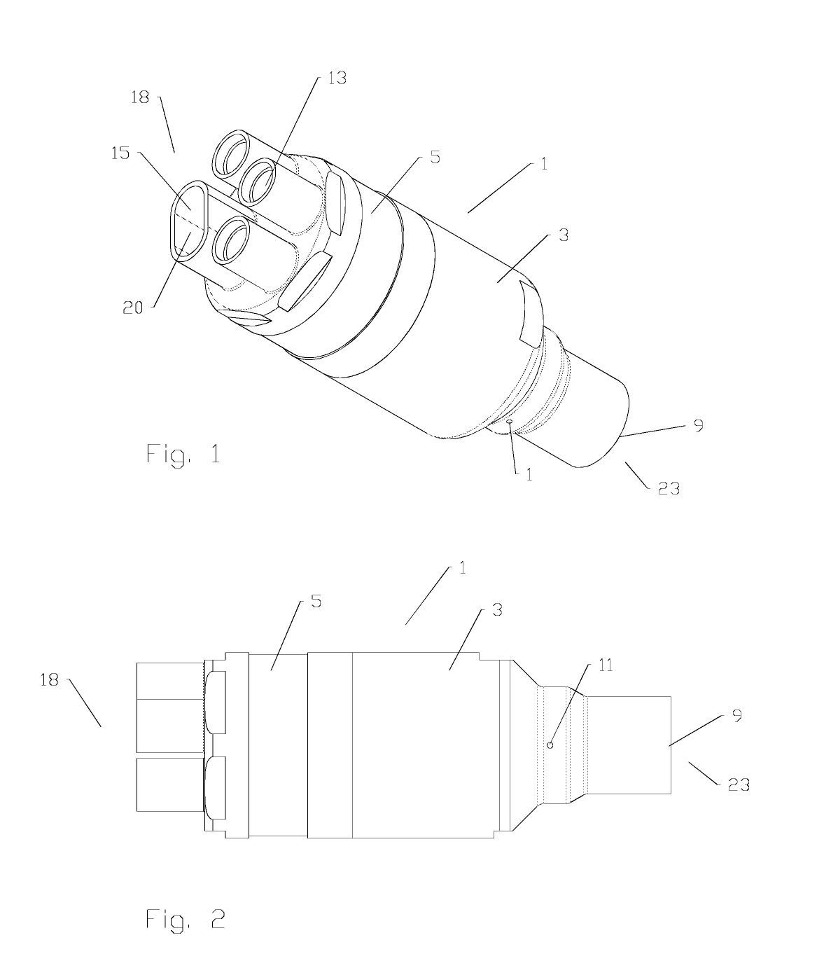

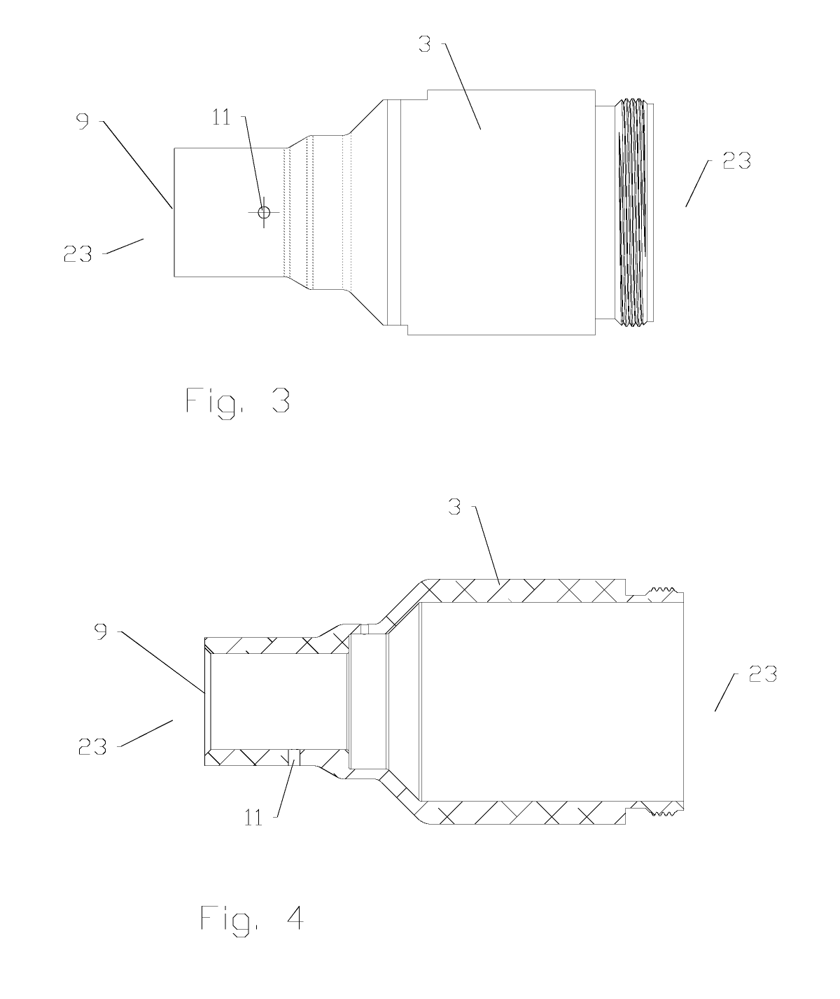

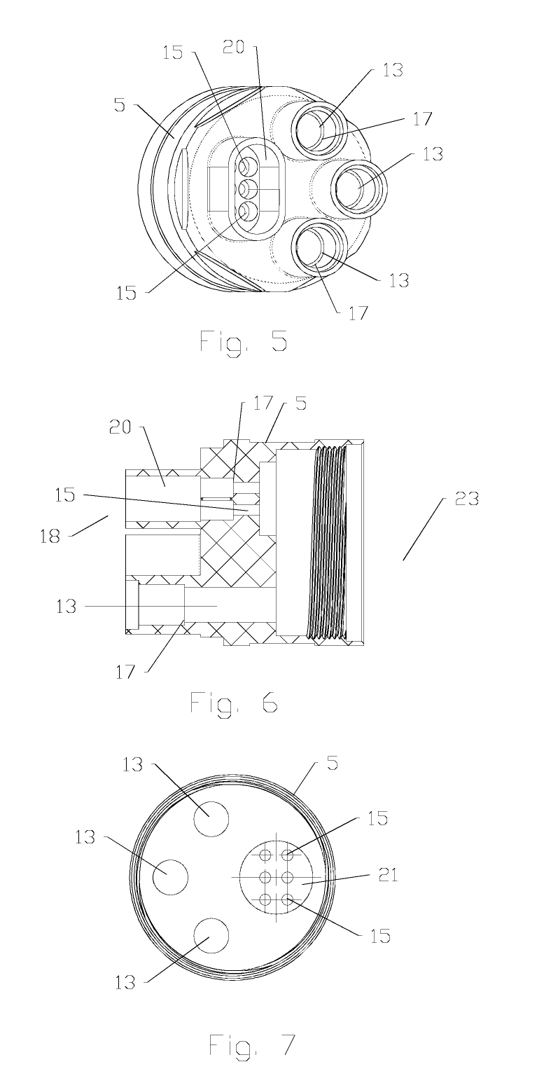

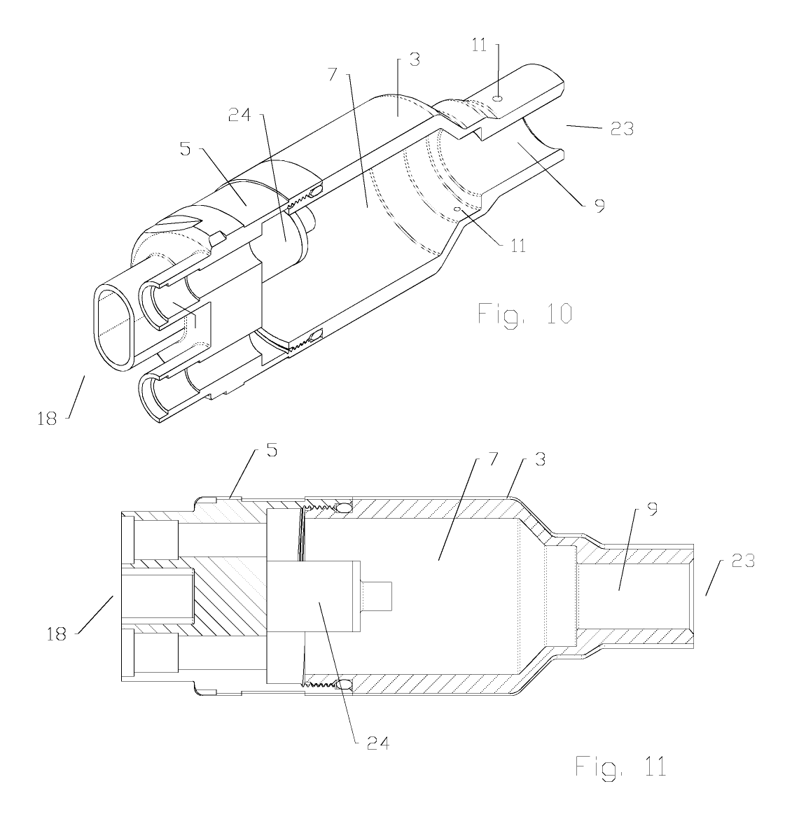

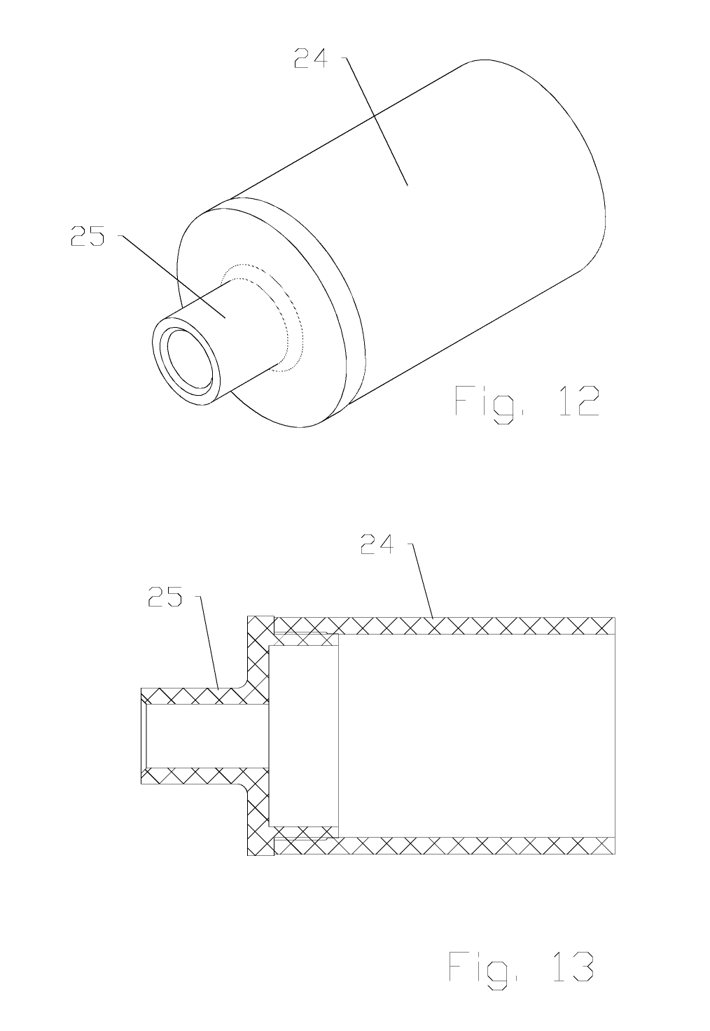

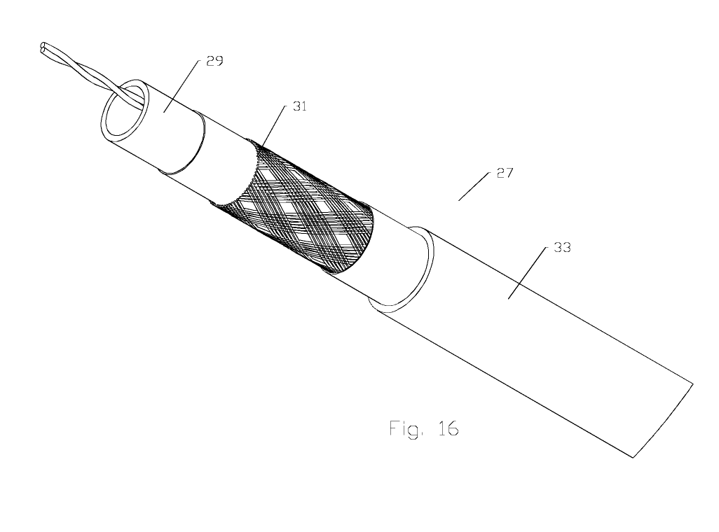

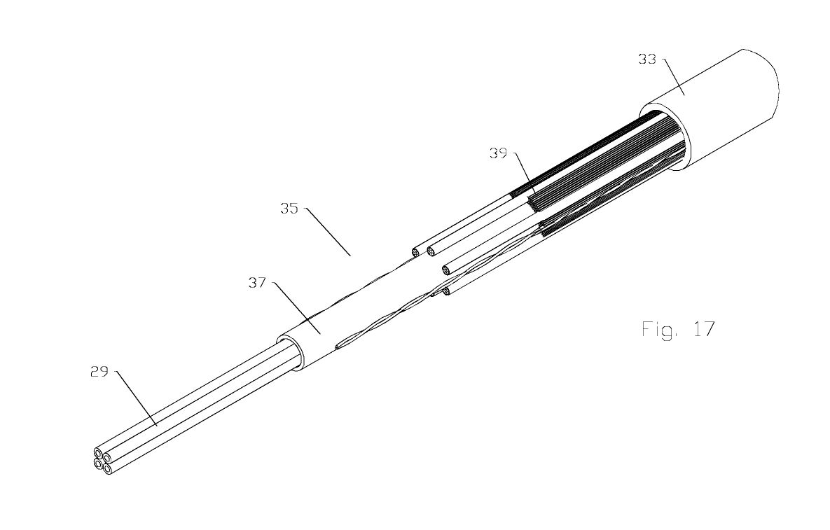

A transition housing 1, for example as shown in FIGS. 1-15, surrounds the transition of the hybrid cable to the furcation tubes. The transition housing 1 may be provided, for example, as a polymer or metal material housing with a cable portion 3 (FIGS. 3 and 4) and a furcation portion 5 (FIGS. 5-7) that mate within one another to enclose a break-out area 7 (best shown in FIGS. 8-11). The transition housing 1 may be formed, for example, by injection molding, machining and/or insert molding.

The cable portion 3 includes a cable port 9 dimensioned to receive the hybrid cable. The cable port 9 may be dimensioned to enable the cable portion 3 to be drawn over the cable end and any shielding and/or outer jacket of the hybrid cable during installation to allow mounting the furcation portion 5 close to the end of the outer jacket. The cable portion 3 can then be drawn toward the seated furcation portion 5 for sealing of the furcation area 7. The mating between the cable and furcation portions 3, 5 may be, for example, via threads, interference and/or snap fit, or alternatively via fasteners such as screws or bolts. The cable and/or furcation portions 3, 5 may include one or more adhesive ports 11 for injecting an adhesive and/or sealant into the furcation area 7 and/or exhausting these areas as the adhesive and/or sealant is applied.

The adhesive may be an epoxy with elastomeric properties.

The furcation portion 5 may include one or more conductor ports 13 and fiber ports 15. The conductor ports 13 may be dimensioned to receive conductor furcation tubes therethrough, into the furcation area 7.

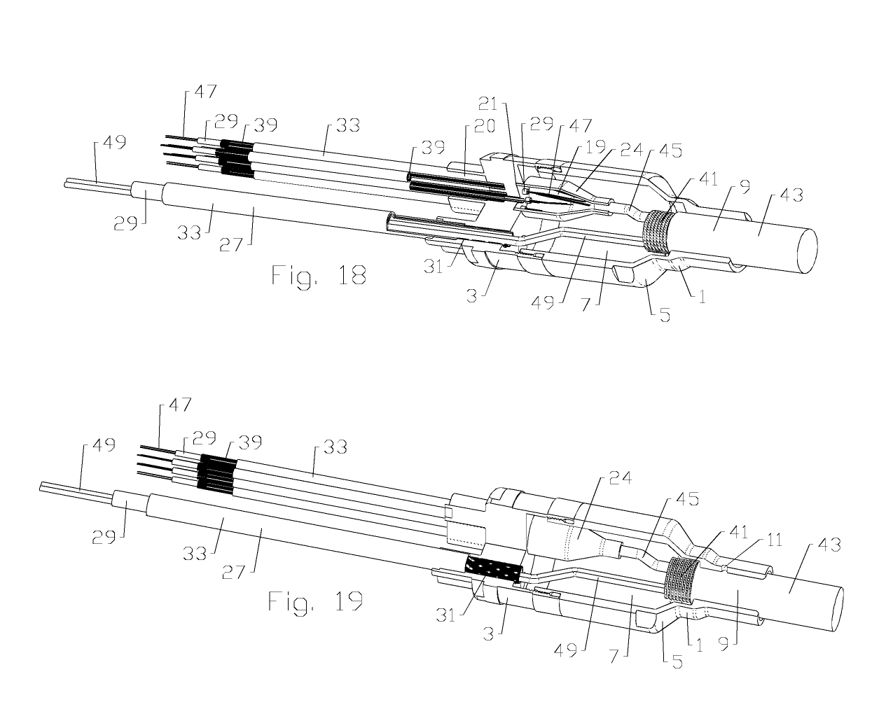

The conductor furcation tubes 27 may include, for example, an inner tube 29, a metallic shield layer 31 and outer jacket 33, for example as shown in FIG. 16. Shielded conductor furcation tubes 27 are described in detail in commonly owned U.S. patent application Ser. No. 13/791,248, titled “Shielded Electrical Conductor Furcation Assembly” filed 8 Mar. 2013 by Nahid Islam, hereby incorporated by reference in its entirety. The fiber furcation tubes 35 may include, for example, an inner jacket 37, a fiber and strength layer 39 and an outer jacket 33, for example as shown in FIG. 17. Damage-resistant fiber furcation tubes 35 are described in detail in commonly owned U.S. patent application Ser. No. 13/832,131, titled “Rugged Furcation Tube” filed 15 Mar. 2013 by Nahid Islam, hereby incorporated by reference in its entirety. For example, each fiber furcation tube 35 may be dimensioned to receive either 900 um or 250 um optical fibers. Further, each fiber furcation tube 35 may include multiple inner tubes 29, within the inner jacket 37, for separate fibers and/or fiber bundles. The inner tubes 29 may be dimensioned to pass through the fiber ports 15, into the fiber area 19, as shown for example in FIG. 18.

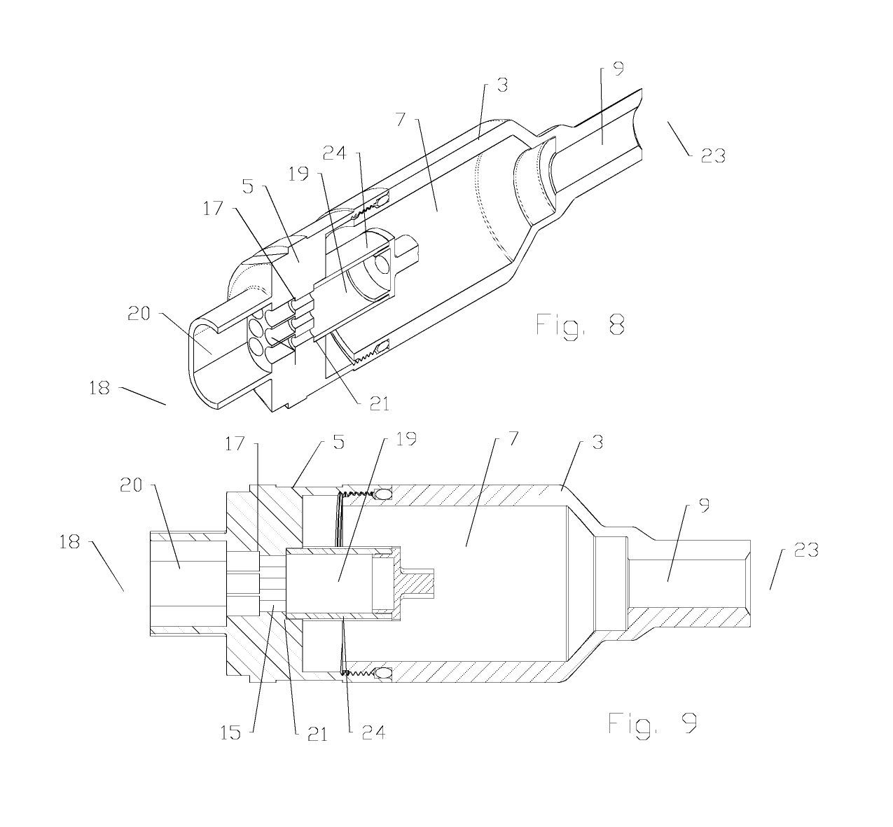

The fiber ports 15 may be dimensioned with a furcation shoulder 17 (see FIG. 6) dimensioned to seat the fiber and strength layer 39 and/or outer jacket 33 of a fiber furcation tube 37, the remainder of the fiber port 15 dimensioned to pass the fiber and/or fiber bundle therethrough. Several fiber ports 15 may be grouped together with an adhesive well 20 projecting from the furcation end 18, for adhering several fiber furcation tubes 35 further to one another, to increase a pull-off resistance characteristic of each individual fiber furcation tube and/or allow an increased amount of adhesive to be applied thereto, so that the furcation end 18 is provided with an elastomeric characteristic to protect the individual fiber furcation tubes 35 from buckling against a lip of the respective fiber ports 15.

The conductor ports 13 may also include a furcation shoulder 17 at the furcation end 18, to allow an increased amount of adhesive to be applied thereto, so that the furcation end 18 is provided with an elastomeric characteristic to increase a pull-off resistance characteristic and/or protect the conductor furcation tubes 27 from buckling against a lip of the conductor port 13.

The fibers 47 are isolated from the furcation area 7 to prevent their immobilization in adhesive injected within the furcation area 7. Thereby, the fibers 47 may be isolated from stresses generated by thermal expansion differentials that may exist between metal and/or polymeric portions of the assembly and the fibers. That is, the fibers 47 are free floating between the cable 43 and the fiber furcation tube 35.

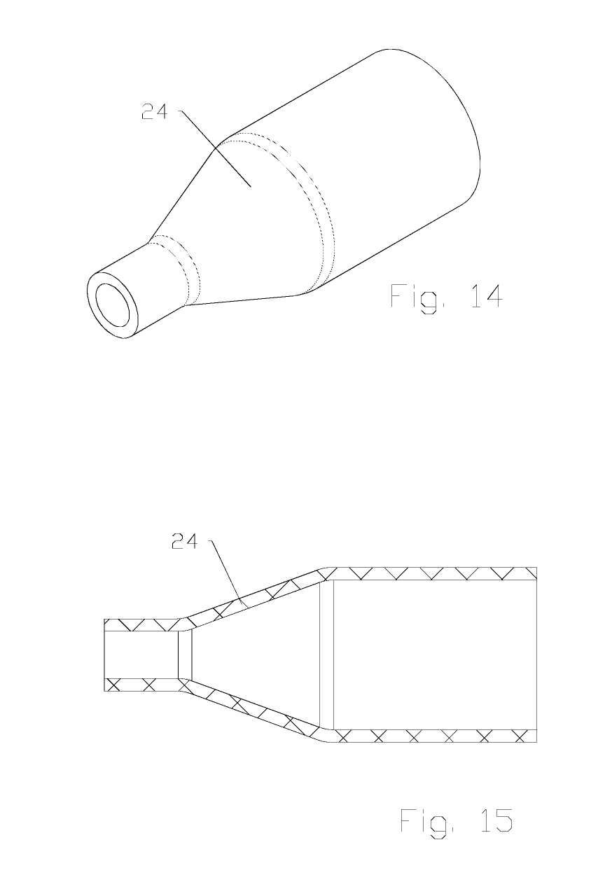

The fiber area 19 (see FIGS. 8 and 9) wherein the individual fibers transition from the fiber bundle 45 of the cable 43 to their respective fiber furcation tubes 35 may be provided, for example, via an inner wall portion 24 that seats into a fiber area shoulder 21 (see FIG. 7-9) of the transition end 23 of the furcation portion 5 surrounding the fiber ports 15 and is sealed against a fiber bundle 45 of the cable 43 by an end stop 25 sealing between an outer jacket of the fiber bundle 45 and the inner wall portion 24. Where the inner wall portion 24 is cylindrical, the end stop 25 may be provided as a polymeric annular gasket or the like, seated sealing on an inner diameter against the outer jacket of the fiber bundle 45 and on an outer diameter against an inner diameter of a bore of the inner wall portion 24, as shown for example in FIGS. 12 and 13. Alternatively, the inner wall portion 24 may be formed with, for example, a conical reduction proximate the transition end 23, wherein the transition end 23 has an inner diameter proximate an outer diameter of the outer jacket of the fiber bundle 45, for example as best shown in FIGS. 14, 15 and 18. One skilled in the art will appreciate that the fiber bundle 45 may be a fiber subunit of the cable 43 which encloses a single fiber 47 or a plurality of fibers 47.

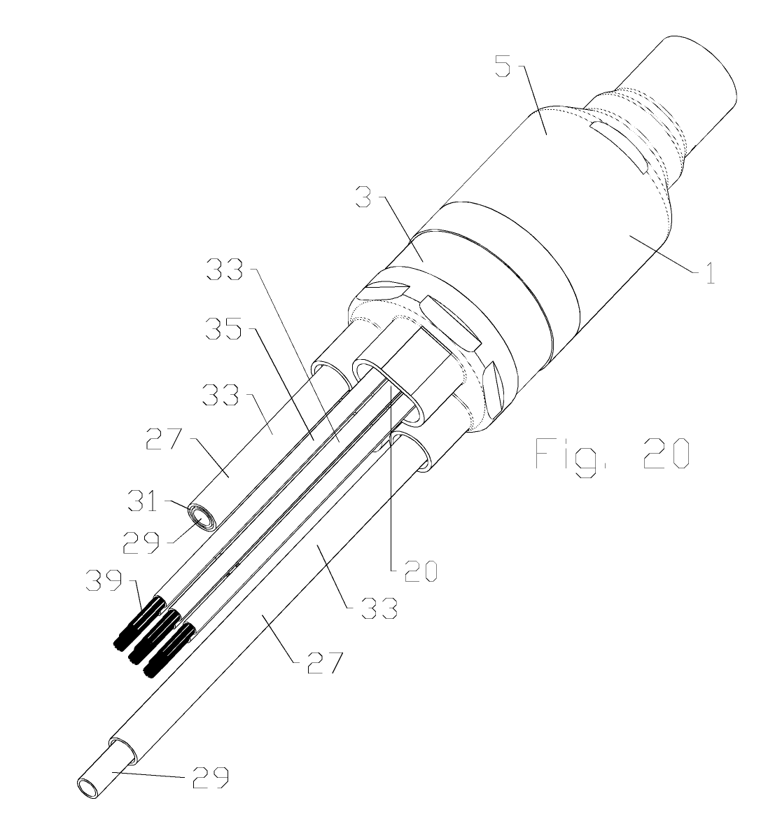

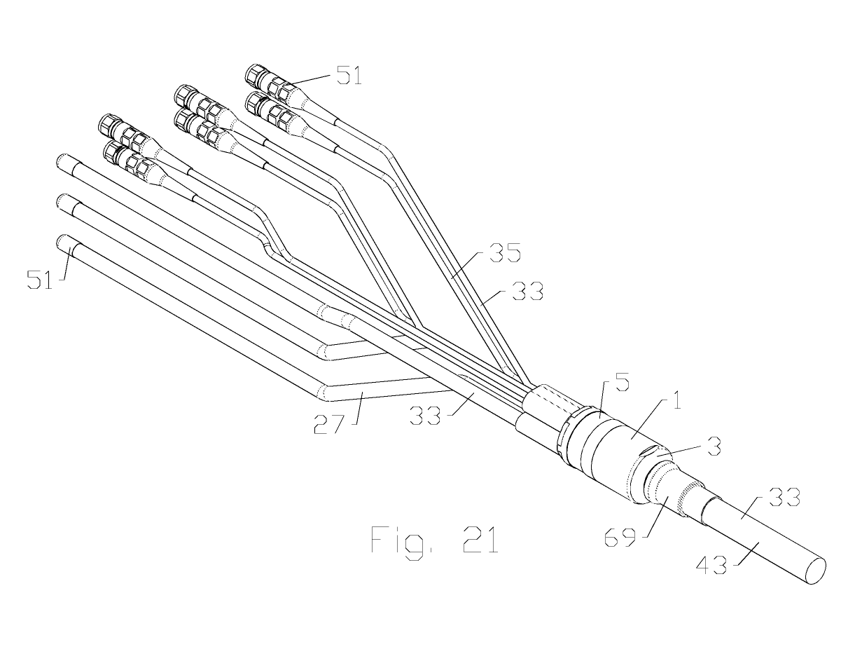

To manufacture an assembly, for example as shown in FIGS. 18-21, the cable 43 has the outer jacket 33 and any shield 41 stripped back to expose desired lengths of the fiber 47, electrical conductors 49 and/or fiber bundles 45. The cable portion 3 is advanced over the conductors and over the outer jacket 33 of the cable 43 and the end stop 25 (if present) and inner wall portion 24 advanced over the fiber bundle 45. The furcation portion 5 is advanced over the conductors, each of the conductors and/or conductor bundles inserted to respective fiber and/or conductor furcation tubes 35, 27, the conductor furcation tubes 27 passed through conductor ports 13 and fiber furcation tubes 35 seated in their respective furcation shoulders 17, for example as shown in FIGS. 18 and 19. The metallic shield layer 31 of the conductor furcation tubes 27 may be coupled to a drain wire and/or the shield 41 of the cable 43, for example via a shield interconnection, such as a tie wire, fastener, soldering or the like. The shield interconnection and fiber area 19 (inner wall portion 24 sealed against the transition end 23 of the furcation portion 25 by seating in the fiber area shoulder 21 and closed by the end stop 24) are enclosed by returning the cable portion 3 towards the furcation portion 5 and coupling them together (see FIG. 19).

The furcation area 7 may then be sealed/encapsulated by injecting a desired adhesive (also known as a sealant or caulk) into the adhesive port(s) 11 of the cable and/or furcation portions 3, 5, until the adhesive is observed, for example, at the cable port 9 and/or conductor ports 13. Further adhesive may be applied to seal the fiber furcation tubes 35 into the furcation shoulders 17 of the fiber ports 15 and the fiber furcation tubes 35 to one another within the adhesive well 20 of the furcation portion 5. Splaying a fiber portion of the fiber and strength layer 39 so that it extends within the furcation shoulder 17 and/or further into the adhesive well 20 (see FIG. 18) provides secure retention of the fiber furcation tubes 35 to the furcation portion 5 and thereby to the assembly.

The transition housing 1, individual conductor ports 13 and/or the adhesive well 20 may be further sealed by applying shrink tubing 69 or pultruded seals therearound, for example as shown in FIGS. 21, 35 and 36.

The assembly may be further completed by applying desired connectors to each of the conductors at the end of their respective furcation tubes, as best in FIG. 21.

A grounding lug may be applied to the transition housing and/or a grounding lead may be routed from the junction of the cable shield/drain wire and conductor furcation tube shields to the sidewall of the assembly (if conductive) or in a sealed fashion to an exterior of the assembly to provide a ready grounding point for the cable assembly.

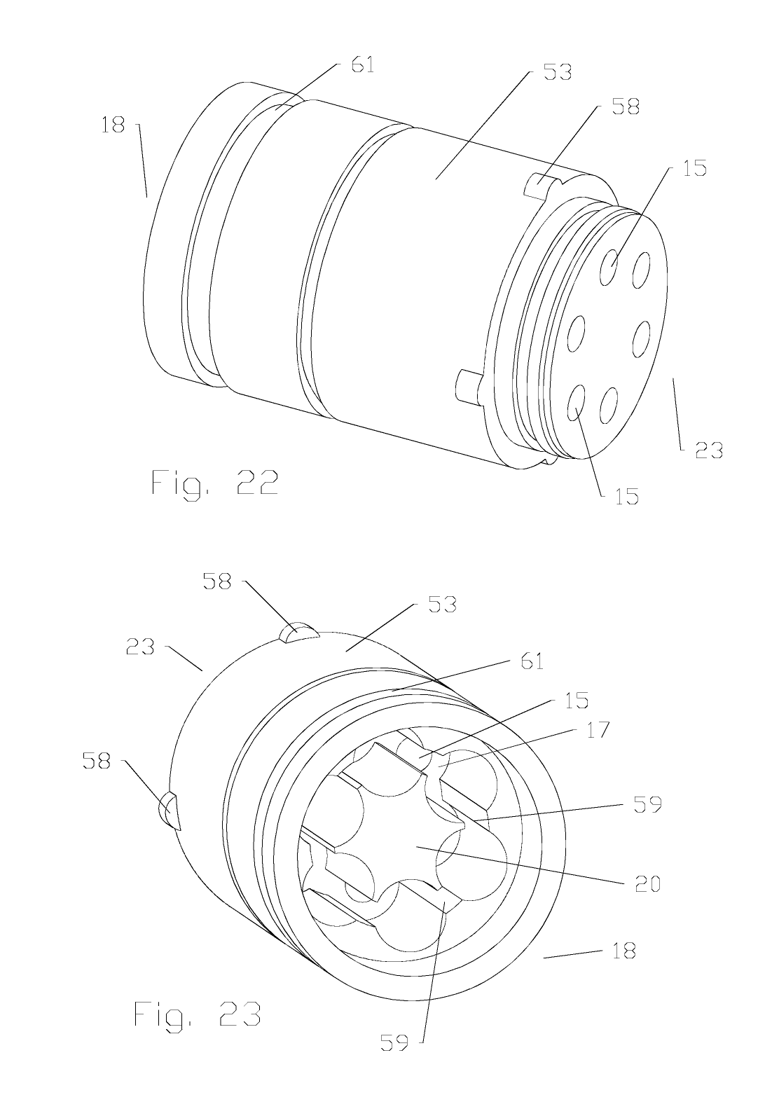

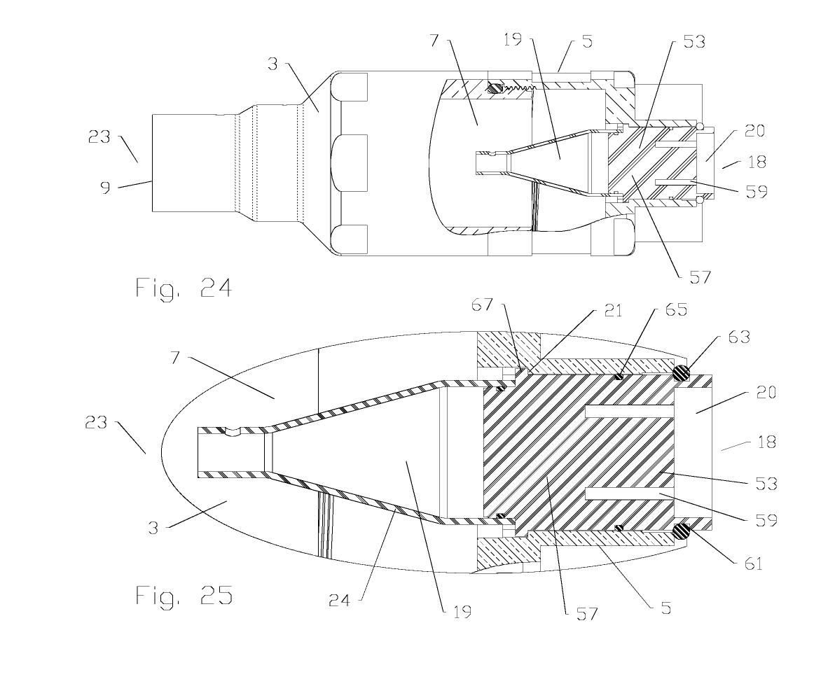

In a further embodiment, the inner wall portion 24 may be provided with a fiber capsule cap 53 which includes the fiber port(s) 15, for example as shown in FIGS. 22 and 23, The inner wall portion 24 and fiber capsule cap 53 mate together to form a fiber capsule 55 that encloses the fiber area 19, as shown in FIGS. 24 and 25.

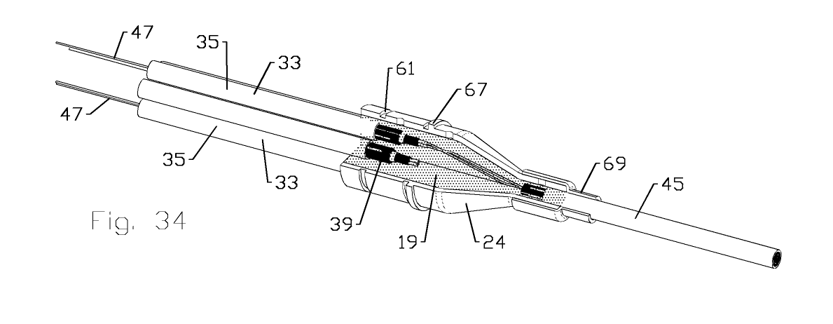

When a fiber capsule 55 is applied, the furcation portion 5 may be simplified to include a fiber capsule port 57, instead of the multiple fiber ports 15 and adhesive well features. The fiber capsule port 57 may include a fiber area shoulder 21 dimensioned to receive a stop rim 67 of the fiber capsule cap 53 or the inner wall portion 24, for example as shown in FIGS. 25 and 33. Thereby, the manufacture of the furcation portion 5 is simplified by transferring the formation of the several small holes of the fiber ports 15 and associated surface features to a much smaller overall element, such as the fiber capsule cap 53, where the overall scale of the element is closer to that of the dimensions of the fiber port(s) 15, simplifying the corresponding mold and/or machining requirements. Further, multiple fiber capsule caps 53 may be cost efficiently manufactured/provided, with varying numbers of fiber ports 15 and or fiber port dimensions, to match the number and/or type of fibers 47 that are present in the desired cable assembly. Thereby, a single furcation portion 5 configuration may be utilized with a range of cables, including cables with different numbers and/or types of fibers 47.

The fiber capsule cap 53 may include an adhesive well 20 at the furcation end 18, as best shown in FIG. 23. The furcation shoulders 17 of the fiber ports 15 may include sidewall slots 59 communicating between the furcation shoulders 17 of adjacent fiber ports 15. The sidewall slots 57 may enable additional intermingling and mutual reinforcement of splayed fiber portions of the fiber and strength layer 39 so that they extend deeply within more than a single furcation shoulder 17 and/or are distributed further about the adhesive well 20. The increased intermingling and/or distribution of the splayed fiber portions provide enhanced retention of the fiber furcation tubes 35 to the fiber capsule cap 53 and thereby to the assembly, upon application of adhesive to the adhesive well 20.

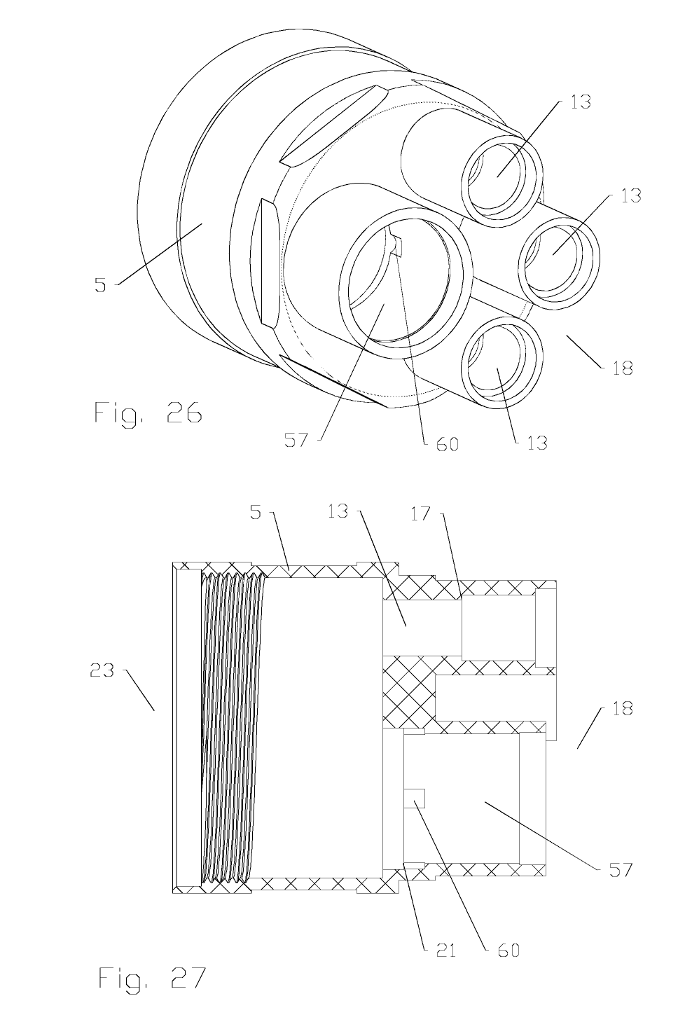

The furcation capsule 53 may be provided with one or more rotational interlock features, such as projections 58, on the outer diameter, for example provided on the fiber capsule cap 53 (see FIGS. 22 and 23), which key with corresponding sockets 60 provided in the sidewall of the fiber capsule port 57 (see FIGS. 26 and 27) to rotationally interlock the furcation capsule 53 with the furcation portion 5. Alternatively, the rotational lock features may be applied to the inner wall portion 24.

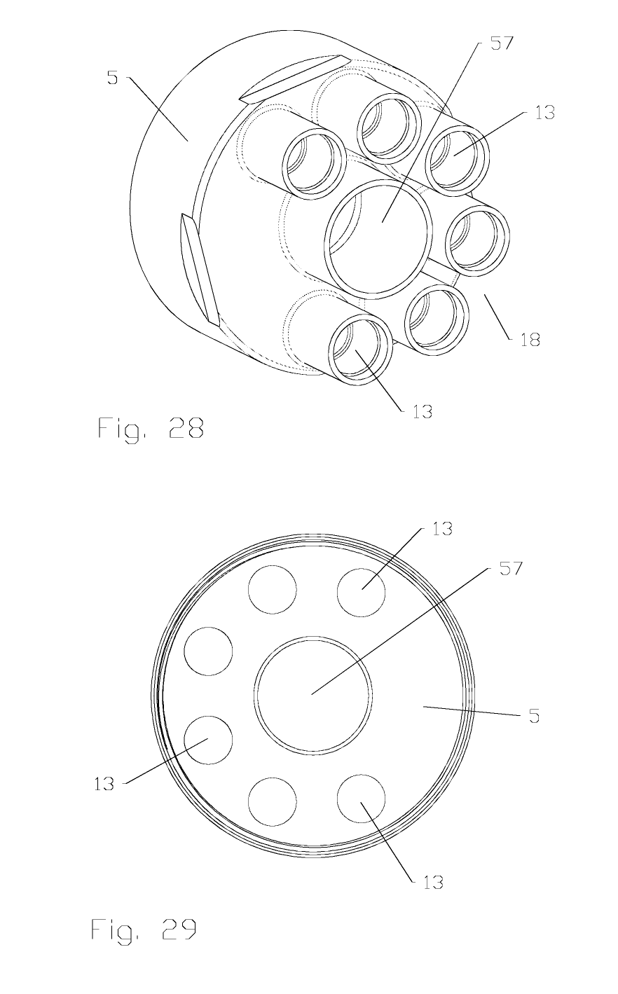

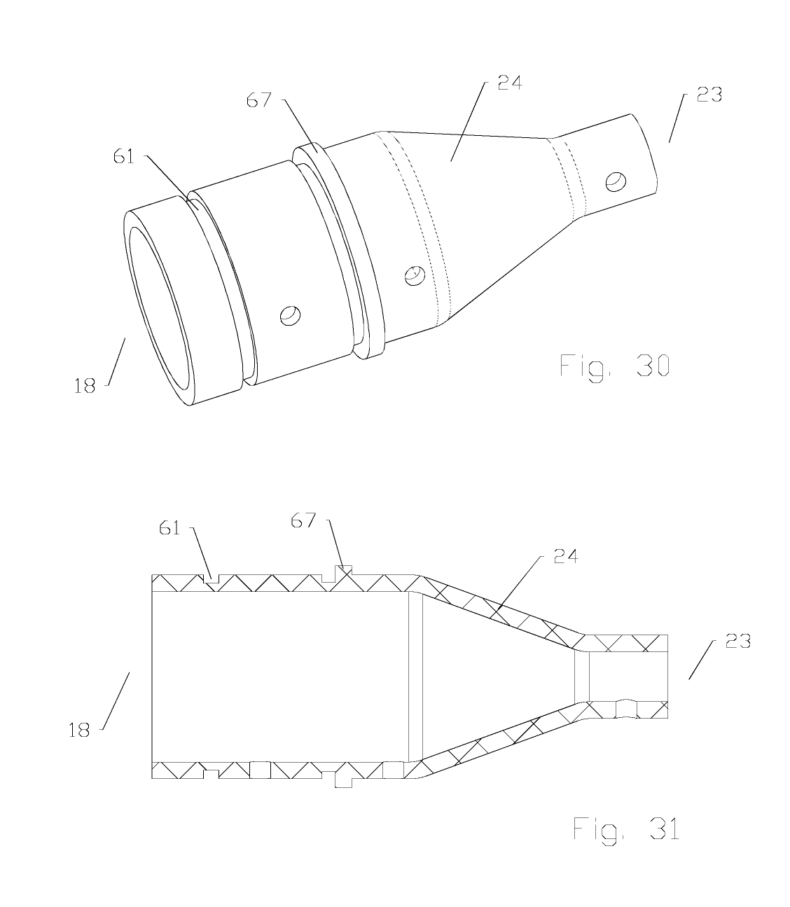

The furcation portion 5 has been demonstrated with the inner wall portion 24 and associated fiber area 19 provided off-center with respect to a cross-section of the furcation portion 5, for example for ease of assembly. Alternatively, in a trade-off with ease of assembly, the furcation portion 5 may be configured such that inner wall portion 24 or fiber capsule 55 seat is proximate a center of the furcation portion 5, with the conductor ports 9 arrayed there around. Thereby, the fiber furcation tubes 35 may be shielded from harm by the more robust conductor furcation tubes 27. Providing the conductor ports 9 grouped to leave an access area around a centrally positioned fiber capsule port 57, for example as shown in FIGS. 28 and 29, provides a balance of protection and ease of assembly.

Manufacture of an assembly including a fiber capsule 55 is similar to the description of the previous embodiment except that the fibers inserted into the inner wall portion 24 are also passed through respective fiber ports 15 of the capsule cap 53 which is then seated upon the furcation end 18 of the inner wall portion to form the fiber capsule 55. The fibers are further passed through the fiber capsule port 57 and the fiber capsule 55 seated in the fiber capsule port 57.

The fiber capsule cap 53 may include a retention groove 61 on the outer diameter, positioned to seat a retainer 63 such as an o-ring, c-clip, snap ring or the like, to retain the fiber capsule 55 seated in the fiber capsule port 57 as the furcation portion 5 and cable portion 3 are mated together and encapsulating adhesive is applied to the furcation area 7. Where the retainer 63 is a clip or retaining ring, an environmental seal 65 may be applied to the outer diameter of the capsule cap 53 to seal external access to the furcation area 7 and/or prevent injected adhesive from leaking along the fiber capsule 55 and fiber capsule port 57 interconnection.

The fiber capsule port 57 enables initial preparation of the fiber area 19 and fiber furcation tubes 35, which are then passed through the fiber capsule port 57, simplifying assembly.

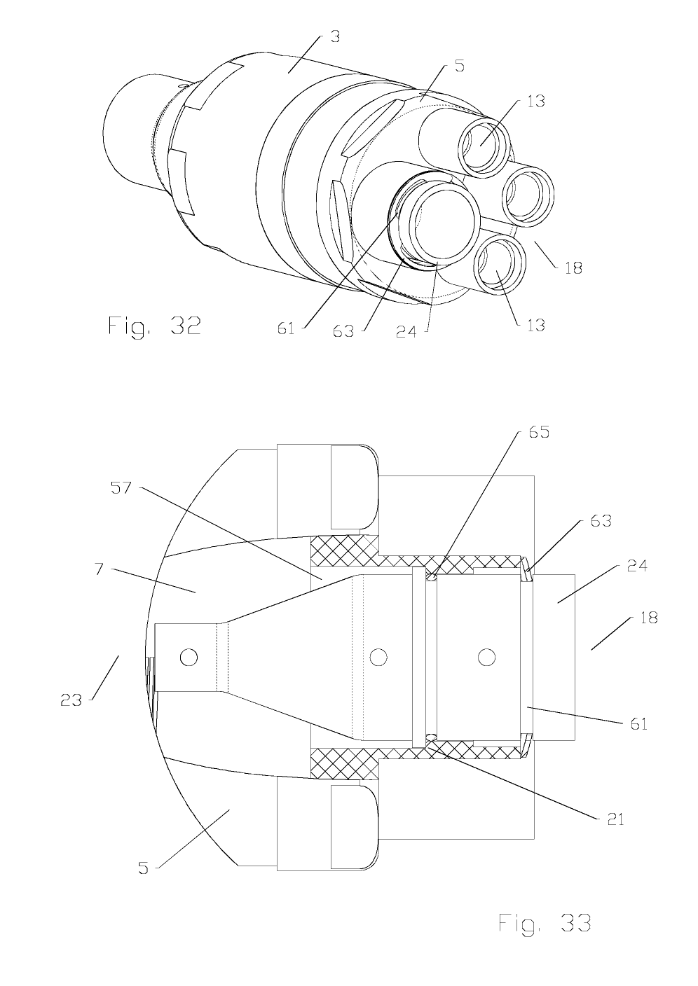

In a further simplification of the fiber capsule 55, the inner wall portion 24 may be adapted to seat within the fiber capsule port 57, without requiring application of a fiber capsule cap 53, for example as shown in FIGS. 30 and 31. A inner wall portion 24 provided with an outer diameter stop rim 67 dimensioned to seat within the fiber area shoulder 21 seats the inner wall portion 24 within the fiber capsule port 57, but does not enable passage entirely therethrough. Similarly, a retention groove 61 may be provided proximate the furcation end 18 of the inner wall portion 24, for application of a retainer 63 to hold the inner wall portion 24 in place within the fiber capsule port 57, for example as shown in FIGS. 32 and 33.

The fiber furcation tubes 35 may be encapsulated within the fiber area 7 as a sub-assembly ready for feeding the fiber furcation tubes 35 through the fiber capsule port 57 of the furcation portion 5, by filling the fiber area 7 with an adhesive, for example as shown in FIG. 34.

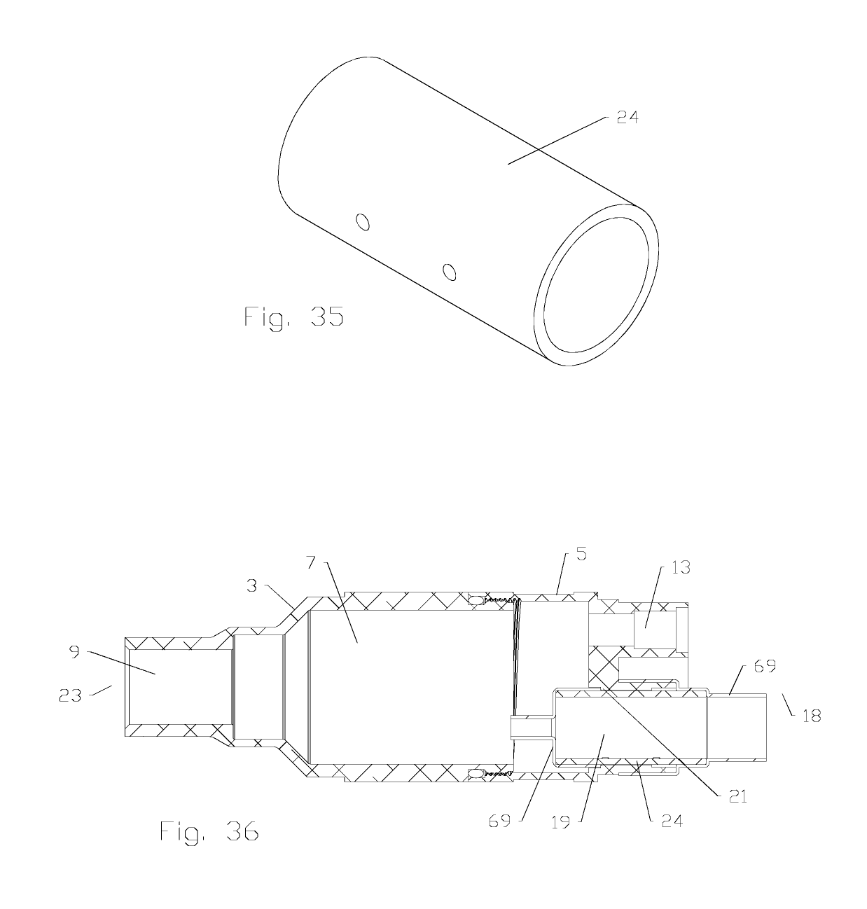

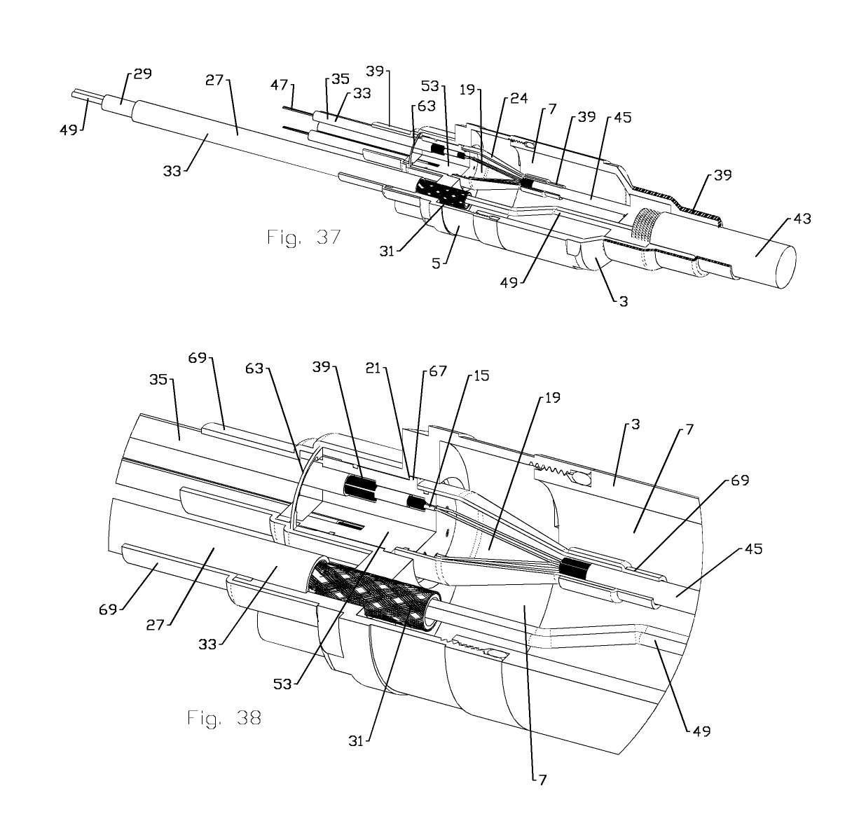

Shrink tubing 69 may be utilized with a simplified inner wall portion 24, for example as shown in FIGS. 35 and 36. In addition to sealing between the inner wall portion 24 and the fiber bundle 45, the leading edge of the shrink tubing 69, adhered to the inner wall portion 24, may provide the stop rim 67 which abuts the fiber area shoulder 21 and/or functions as a retainer 63 at the furcation end of the inner wall portion 24 to retain the inner wall portion 24 with respect to the furcation portion 5.

One skilled in the art will appreciate that the assembly provides a splice-free cable conductor distribution with significant pull-apart strength and improved environmental sealing in an assembly with minimal dimensions that eliminates the need for distribution boxes and/or on-site conductor termination during installation. Further, because the fibers 47 and/or electrical conductors 49 may lay freely within their respective inner tubes 29 from the transition housing 1 to the connector 51, the fibers 47 and/or electrical conductors 49 are free of thermal expansion and or tensile stress that may be applied to their respective fiber and conductor furcation tubes 35, 27.

Table of Parts

| | |
|---|---|
| 1 | transition housing |
| 3 | cable portion |
| 5 | furcation portion |
| 7 | furcation area |
| 9 | cable port |
| 11 | adhesive port |
| 13 | conductor port |
| 15 | fiber port |
| 17 | furcation shoulder |
| 18 | furcation end |
| 19 | fiber area |
| 20 | adhesive well |
| 21 | fiber area shoulder |
| 23 | transition end |
| 24 | inner wall portion |
| 25 | end stop |
| 27 | conductor furcation tube |
| 29 | inner tube |
| 31 | metallic shield layer |
| 33 | outer jacket |
| 35 | fiber furcation tube |
| 37 | inner jacket |
| 39 | fiber and strength layer |
| 41 | shield |
| 43 | cable |
| 45 | fiber bundle |
| 47 | fiber |
| 49 | electrical conductor |
| 51 | connector |
| 53 | fiber capsule cap |
| 55 | fiber capsule |
| 57 | fiber capsule port |
| 58 | projection |
| 59 | sidewall slot |
| 60 | socket |
| 61 | retention groove |
| 63 | retainer |
| 65 | environmental seal |
| 67 | stop rim |
| 69 | shrink tubing |

Where in the foregoing description reference has been made to materials, ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A cable breakout kit, comprising:
a cable portion;
a furcation portion; and
an inner wall portion;
the cable portion and the furcation portion dimensioned to couple with one another, enclosing a furcation area;
the inner wall portion dimensioned for coupling to the furcation portion and a fiber bundle of the cable, a fiber area provided within the inner wall portion.

2. The cable breakout kit of claim 1, wherein a fiber capsule cap is dimensioned to couple to a furcation end of the inner wall portion, the fiber capsule cap dimensioned to seat in a fiber capsule port of the furcation portion.

3. The cable breakout kit of claim 2, further including at least one fiber port in the fiber capsule cap; the fiber port communicating the fiber area to a furcation end of the fiber capsule cap.

4. The cable breakout kit of claim 3, further including an adhesive well projecting from a furcation end of the fiber capsule cap, surrounding the at least one fiber port.

5. The cable breakout kit of claim 4, wherein the adhesive well surrounds a plurality of the fiber ports; at least two of the fiber ports provided each with a furcation shoulder; and a sidewall slot is provided interconnecting the furcation shoulders.

6. The cable breakout kit of claim 2, wherein the fiber capsule cap is dimensioned to rotationally interlock with the fiber capsule port.

7. The cable breakout kit of claim 1, wherein the inner wall portion is dimensioned to seat in a fiber capsule port of the furcation portion.

8. The cable breakout kit of claim 7, further including a retention groove provided in an outer diameter of the inner wall; the retention groove positioned proximate a furcation end of the furcation portion; and a retainer dimensioned to seat in the retention groove.

9. The cable breakout kit of claim 2, further including a retention groove provided in an outer diameter of the fiber capsule cap; the retention groove positioned proximate a furcation end of the furcation portion when the fiber capsule cap is seated within the fiber capsule port; and
a retainer dimensioned to seat in the retention groove.

10. A method for furcating a cable, comprising steps of:
inserting the cable through a cable port of a cable portion;
inserting at least one fiber of the cable through an inner wall portion and a furcation portion;
inserting the fiber through a fiber furcation tube and seating the fiber furcation tube in at least one fiber port of the furcation portion;
inserting an electrical conductor of the cable through the furcation portion and a conductor furcation tube and seating the conductor furcation tube in a conductor port of the furcation portion; and
coupling the cable portion and the furcation portion to one another, enclosing a furcation area therewithin; a fiber area within the inner wall portion isolated from the furcation area.

11. The method of claim 10, further including filling the furcation area with an adhesive.

12. The method of claim 11, wherein the furcation area is filled with the adhesive via an adhesive port through one of the cable portion and the furcation portion.

13. The method of claim 10, further including filling the fiber area with an adhesive.

14. The method of claim 10, wherein the fiber area is isolated from the furcation portion.

15. The method of claim 14, wherein the inner wall portion is seated within a fiber capsule port of the furcation portion.

16. The method of claim 14, wherein a fiber capsule cap is seated upon a furcation end of the inner wall portion and the fiber capsule cap is seated within a fiber capsule port of the furcation portion.

17. A furcated cable assembly, comprising
a cable with a fiber and an electrical conductor;
a transition housing coupled to the cable, a fiber furcation tube and
a conductor furcation tube;
the fiber passing through the transition housing and into the fiber furcation tube;
the electrical conductor passing through the transition housing and into the conductor furcation tube;
the electrical conductor passing through a furcation area of the transition housing and the fiber passing through a fiber area of the transition housing, which is isolated from the furcation area.

18. The furcated cable assembly of claim 17, wherein the fiber area is isolated from the furcation portion.

19. The furcated cable assembly of claim 17, wherein the fiber is free floating between the cable and the fiber furcation tube.

20. The furcated cable assembly of claim 17, wherein the fiber area is filled with an adhesive.
